(19) United States
(12) Patent Application Publication
(10) Pub. No.: US 2020/0242548 A1
(43) Pub. Date: Jul. 30, 2020

(54) METHODS, SYSTEMS, AND COMPUTER READABLE MEDIA FOR DRONE-BASED DELIVERY OF HEALTHCARE AND OTHER SENSITIVE OR HIGH-VALUE ARTICLES

(71) Applicant: North Carolina State University, Raleigh, NC (US)

(72) Inventors: Adam Craig Curry, Raleigh, NC (US); Stuart David Ginn, Raleigh, NC (US)

(21) Appl. No.: 16/773,468

(22) Filed: Jan. 27, 2020

Related U.S. Application Data
(60) Provisional application No. 62/796,622, filed on Jan. 25, 2019.

(51) Int. Cl. G06Q 10/08; G07C 9/00; B64C 39/02

(52) U.S. Cl. CPC G06Q 10/0832; G06Q 10/0833; B64C 2201/128; B64C 39/024; G07C 2009/0092; G07C 9/00896

(57) ABSTRACT

A system for drone-based delivery of sensitive or high-value articles includes a smart container having a housing defining an interior region for holding sensitive or high-value articles and an exterior region for transport using a drone. The system includes a processor, a memory, and a communications circuit coupled to the housing. The system further includes a location circuit for outputting location data indicative of a location of the smart container. The system further includes a sensor for sensing a parameter indicative of a condition of the smart container and for generating output indicative of the condition. The system further includes a smart container content condition reporter for generating, based on the output from the sensor and the location data, location-context-specific output indicative of a condition of contents of the smart container given a location of the smart container when the output from the sensor is generated.

### PRIORITY CLAIM

This application claims priority to U.S. Provisional Patent Application Ser. No. 62/796,622, filed Jan. 25, 2019, the disclosure of which is incorporated herein by reference in its entirety.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### TECHNICAL FIELD

The subject matter described herein relates to a smart shipping container for delivery of sensitive or high-value articles. More particularly, the subject matter described herein relates to methods, systems, and computer readable media for drone-based delivery of healthcare and other sensitive or high-value articles.

### BACKGROUND

Owing to a unique set of capabilities, drones have recently emerged as a promising option for product delivery. As used herein, the term “drone” refers to an unaccompanied vehicle that is capable of transporting articles by land, air, or water. An example of a drone that can carry articles by air is an aerial vehicle, such as a rotorcraft. Examples of drones that can carry articles by land or water include unaccompanied automobiles, boats, and underwater vehicles. A drone can be autonomous, meaning that the drone is programmed with a destination and travels to the destination without external control input. A drone can also be remotely controlled by a human or machine.

The programmability and autonomy of drones enable delivery with significantly lower personnel demands than manned vehicles—drones require no personnel for operations during transport, and when monitoring of operations during transport is desired, one operator can monitor numerous drones on delivery at the same time. By flying directly point-to-point, aerial drones are oftentimes able to provide delivery faster than ground transport, which is limited by road routes and road traffic. Finally, the low and decreasing costs of the enabling technologies for location tracking (for example, via Global Navigation Satellite Systems, abbreviated GNSS, or global positioning systems, abbreviated GPS), computing, communications, batteries, and other functions are making drones increasingly accessible.

For these reasons, drones have been proposed and/or used for delivery of items including consumer goods, food, and medical products. When used for delivery of medical products, drones are likely to reduce delivery costs; enable more rapid diagnosis and treatment of disease; overcome barriers to healthcare access; and facilitate new healthcare paradigms.

However, the requirements for delivery of many medical goods are often unique and/or more stringent, as compared to delivery of other categories of goods (within the broad category of medical goods, there is also variability in the requirements for various products, such as devices, pharmaceuticals, lab specimens, blood products, implantables, etc.). This is due, in large part, to the importance of medical products on the health, wellbeing, and/or survival of individuals and the public, which increases the necessity of safe and reliable delivery. Medical products are also likely to be sensitive, increasing the complexity of shipment, and have high monetary value, increasing the desire for security. Finally, medical products often are regulated with respect to access, environmental controls, biohazardous risk, and patient confidentiality.

While these requirements apply to traditional delivery of the same goods, drone-based delivery of these goods introduces unique considerations and challenges. First, the unattended (often termed “unmanned”, as in “unmanned aircraft”, the FAA designation for flying drones) nature of drone delivery means that no individual is present with the container to maintain possession of the contained products, monitor conditions, and provide security, including preventing unauthorized access. This increases the importance of container security measures, such as the use of locking containers; location-tracking; traceability; and monitoring of payload conditions (such as temperature, container access, etc.). Second, as compared with delivery by traditional means, such as by automobile, some drone delivery vehicles, such as small flying drones, leave the products more exposed to damage, which may introduce new requirements for protection from unintended impact. Such protection is especially important in the cases of controlled substances and lab specimens, both of which are carefully regulated. Third, faster delivery by drone may reduce the timespan over which control of conditions is required, reducing the container size and weight. In the case of temperature maintenance, as an example, the reduced time required for delivery may reduce the amount of insulation required. Fourth, the compatible payload volumes and weights are likely to be smaller on drones, making space efficiency and weight more significant considerations. This list is not considered to be comprehensive and is presented to illustrate ways in which drone-based delivery introduces unique considerations and challenges, as compared with traditional delivery means.

Considering these and numerous other potential differences between a) medical and non-medical deliveries and b) drone-based and traditional delivery, drone-optimized packaging solutions are needed. As addressed by the subject matter disclosed herein, a drone-optimized packaging solution should 1) ensure product security; 2) provide data acquisition and reporting; 3) maintain appropriate environmental conditions; and 4) facilitate portability.

To address some of these issues, containers with embedded sensors have been developed. For example, some shipping containers include wall embedded accelerometers to detect tampering with the shipping containers or thermocouples to detect temperature excursions during transit. However, interpreting such sensor data lacks context. For example, it may be acceptable for a shipping container to experience a given level of vibration or for the container interior to reach certain temperatures during loading and unloading but not during transit. The raw output from an accelerometer or temperature indicator, independent of location data, would not provide such context.

Current solutions are inadequate to address these needs. Accordingly, there exists a need for improved methods, systems, and computer readable media for drone-based delivery of healthcare and other sensitive or high-value articles.

### SUMMARY

A system for drone-based delivery of sensitive or high-value articles includes a smart container having a housing defining an interior region for holding sensitive or high-value articles and an exterior region configured for transport using a drone. The system includes a processor, a memory, and a communications circuit coupled to the housing. The system further includes a location circuit for outputting location data indicative of a location of the smart container. The system further includes a sensor for sensing a parameter indicative of a condition of the smart container and for generating output indicative of the condition. The system further includes a smart container content condition reporter for generating, based on the output from the sensor and the location data output by the location circuit, location-context-specific output indicative of a condition of contents of the smart container given a location of the smart container when the output from the sensor is generated.

According to another aspect of the subject matter described herein, the housing includes a first portion and a second portion, the first portion and the second portion each including at least one sidewall, where the at least one sidewall of the first portion fully encloses the at least one sidewall of the second portion.

According to another aspect of the subject matter described herein, the housing includes an opening to allow access to the interior region and at least one slidable panel for sliding over the opening to block access to the interior region.

According to another aspect of the subject matter described herein, the housing includes an opening to allow access to the interior region, a hinge, and a cover coupled to the housing via the hinge, wherein the cover includes a first position for preventing access to the interior region and a second position for allowing access to the interior region.

According to another aspect of the subject matter described herein, the smart container includes a locking mechanism integrated within the housing, the locking mechanism including an actuating member and a plurality of bolts coupled to the actuating member, wherein the actuating member is movable to a first position such that the bolts engage recesses in the housing and to a second position such that the bolts disengage the recesses in the housing.

According to another aspect of the subject matter described herein, the housing comprises a cylinder configured for drone delivery and for transport by a pneumatic tube transport system of a facility.

According to another aspect of the subject matter described herein, the location circuit comprises one of: a global positioning system receiver and a mobile communications network location receiver that receives or determines the location based on signals from a mobile communications network.

According to another aspect of the subject matter described herein, the sensor comprises an on-board sensor of the drone.

According to another aspect of the subject matter described herein, the sensor comprises an on-board sensor of the smart container.

According to another aspect of the subject matter described herein, the output from the sensor indicates at least one of position and orientation of the smart container and smart container content condition reporter is configured to determine the condition of the contents of the smart container given a location of the smart container when the output from the sensor is generated.

According to another aspect of the subject matter described herein, the sensor comprises an environmental sensor and the output from the sensor includes values of an environmental parameter in the interior region and the smart container content condition reporter is configured to determine the condition of the contents of the smart when the output from the sensor is generated.

According to another aspect of the subject matter described herein, the smart container includes a power supply located within or on the housing or on the drone.

According to another aspect of the subject matter described herein, the communications circuit communicates with a smart container contents condition and delivery monitoring system via communication circuitry of the drone.

According to another aspect of the subject matter described herein, communications circuit communicates with a smart container contents condition and delivery monitoring system directly without using communications circuitry of the drone.

According to another aspect of the subject matter described herein, the communications circuit is configured to communicate the output indicative of the condition of the contents of the smart container to a smart container contents condition and delivery monitoring system during transport of the smart container by the drone.

According to another aspect of the subject matter described herein, the smart container content condition reporter is configured to record the output indicative of the condition of the contents of the smart container in the memory, and the communications circuit is configured to communicate the output to the smart container content condition and delivery monitoring system at an endpoint of the delivery.

According to another aspect of the subject matter described herein, the drone comprises an unattended aerial vehicle.

According to another aspect of the subject matter described herein, the drone comprises an unattended ground vehicle or unattended water vehicle.

According to another aspect of the subject matter described herein, a method for drone-based delivery of sensitive or high-value articles is provided. The method includes providing a smart container having a housing defining an interior region for holding sensitive or high-value articles and an exterior region configured for transport using a drone; a processor; a memory; and a communications circuit. The method further includes using a location circuit for outputting location data indicative of a location of the smart container. The method further includes using a sensor for sensing a parameter indicative of a condition of the smart container and for generating output indicative of the condition. The method further includes using a smart container content condition reporter for generating, based on the output from the sensor and the location data output by the location circuit, location-context-specific output indicative of a condition of the contents of the smart container given a location of the smart container when the output from the sensor is generated.

According to another aspect of the subject matter described herein, a non-transitory computer readable medium having stored thereon executable instructions that, when executed by a processor of a computer, control the computer to perform steps is provided. The steps include, in a smart container having a housing defining an interior region for holding sensitive or high-value articles and an exterior region configured for transport using a drone; a processor; a memory; and a communications circuit, initiating a smart container content condition reporter. The steps further include receiving, by the smart container content condition reporter, location data output from a location circuit and indicative of a location of the smart container. The steps further include receiving, by the smart container content condition reporter, output from a sensor that senses a parameter indicative of a condition of the smart container. The steps further include generating, by the smart container content condition reporter and based on the output from the sensor and the location data output by the location circuit, location-context-specific output indicative of a condition of the contents of the smart container given a location of the smart container when the output from the sensor is generated.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Certain illustrative examples illustrating organization and method of operation, together with objects and advantages may be best understood by reference to the detailed description that follows taken in conjunction with the accompanying drawings in which:

FIG. 1 is a perspective view of a box-style container with a bottom section, top section or lid, latching mechanism, fingerprint scanner to unlatch mechanism, and insulated compartment for temperature maintenance;

FIG. 2 is a perspective view of a box-style container with latching mechanism, fingerprint scanner, power supply, data sensing, processing, storage, and communications capabilities;

FIG. 3 is a perspective view of a cylindrical container compatible with pneumatic tube systems, having a latching mechanism, fingerprint scanner, power supply, data sensing, processing, storage, and communications capabilities;

FIG. 4 is a network diagram of a container and/or drone communicating with a container data infrastructure during flight;

FIG. 5 is a network diagram of a container communicating with data infrastructure preceding or following flight;

FIG. 6 is a network diagram of a container communicating with data infrastructure via drone communications;

FIG. 7 is a network diagram of a container communicating with a container data infrastructure via container communications;

FIG. 8 is a schematic diagram of container electronics receiving power from a drone power supply;

FIG. 9 is a schematic diagram of a container wirelessly receiving energy to charge an on-board power supply, such as a battery, and exchanging data with wireless device at dispatching and/or receiving sites;

FIG. 10 is a schematic diagram of a container receiving data about contents from a Bluetooth-linked barcode scanner;

FIG. 11 is a block diagram illustrating exemplary electronic components of smart container;

FIG. 12 is a flow chart illustrating an exemplary process for transporting sensitive or high-value articles using a smart container;

FIGS. 13A and 13B illustrate an alternate physical configuration for a smart container;

FIGS. 14A and 14B illustrate yet another alternate physical configuration for a smart container;

FIG. 15 illustrates a smart container with an integrated locking mechanism;

FIG. 16 illustrates another example of a smart container within an integrated locking mechanism.

### DETAILED DESCRIPTION

While the subject matter described herein may be implemented in many different forms, there is shown in the drawings and will herein be described in detail specific examples, with the understanding that the present disclosure of such examples is to be considered as an example of the principles and not intended to limit the subject matter described herein to the specific examples shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one example”, “certain examples”, “an example” or similar terms means that a particular feature, structure, or characteristic described in connection with the embodiment is included in at least one embodiment of the present invention. Thus, the appearances of such phrases in various places throughout this specification are not necessarily all referring to the same example. Furthermore, the particular features, structures, or characteristics may be combined in any suitable manner in one or more example without limitation.

Reference throughout this document to a “Container” refers to a receptacle into which products or packages are loaded for transport.

Reference throughout this document to a “Smart” device or system refers to said device or system having features related to data collection, processing, storage, and/or communication.

The subject matter disclosed herein includes a smart package container and associated systems for the safe delivery of medical products and other sensitive or high value products by drone. The solution addresses four key elements for delivering medical products by drone—specifically, it incorporates features to 1) ensure product security; 2) provide data acquisition and reporting; 3) maintain appropriate environmental conditions; and 4) facilitate portability. Numerous other factors, such as cost, usability, and emerging regulatory requirements will also inform the design of an appropriate solution.

Ensuring product security encompasses a) controlling access to the container's contents and b) protecting the container's contents against tampering and/or impact that might, for instance, accompany a crash. Controlling access, which provides access to authorized persons while preventing access by unauthorized persons, is provided by a locking mechanism that prevents opening the container without proper credentials. A mechanism might also be used which prevents detaching the container from the drone without proper credentials. The container might also be integrated into the drone so as to provide a non-removable payload bay, and a mechanism might be used to prevent access to the payload bay's contents without proper credentials. The credentials might preferentially be biometric, such as a person's fingerprints, image, or voice, but may alternatively include passcodes, physical keys, RFID-based keys, encoded digital signals transmitted over Wi-Fi or Bluetooth, or other means recognizable by those skilled in the art.

Protection against tampering and/or impact requires the design of a container that is robust. The container must be sufficiently robust to limit unauthorized access to the container's contents. It must also prevent the container being compromised in the event of a crash or impact, thereby protecting individuals and/or the environment from exposure to certain product-related risks, such as might be associated with controlled substances or patient specimens. Finally, the container must ensure the integrity of the delivered products. For this purpose, the enclosure is designed to meet relevant regulatory standards, such as those issued by the International Air Transport Association (IATA).

Additional protection of the container's contents against uncontrolled access or unintended exposure may be provided by various means, including encasement technologies that engulf the payload, for instance in two-part foams or epoxies deployed in the event the container is compromised, or by means of technologies that destroy, disable, or inactivate the package contents. Protection can also be enabled by the data collection and communications capabilities of the container, which can detect an anomaly and alert responders to initiate a response plan.

Data acquisition and reporting address the need to provide relevant parties with information such as container contents, container location(s), environmental conditions (e.g. temperature, light exposure, humidity, atmospheric pressure, accelerations, and vibration), and identity of the person(s) receiving and opening the container. Container content data may be acquired by sensors such as RFID readers, barcode scanners, cameras, and data entry devices, which may be integrated into the package container or which may be independent of the package container. Container location data may be determined by on-board GNSS sensors, cellular network signals, or location-based identifiers. Environmental condition data may be acquired by a variety of on- or in-container sensors, including thermal sensors, light sensors, humidity sensors, atmospheric pressure sensors, accelerometers, etc. In some situations, data may be reported intermittently, such as at certain delivery waypoints or at the final destination, and in other cases, data may be reported in real-time. Data reported over short range may be accomplished using communication modalities such as Wi-Fi, Bluetooth, and RFID. Data reported over longer distances may be accomplished by communications modalities including radio, cellular networks, and satellite.

Environmental condition maintenance may include control of factors such as temperature, light exposure, humidity, barometric pressure, accelerations, and vibration. It may be desirable to control temperature by means including thermal insulation, passive heating or cooling packs, and/or active temperature control (e.g. via thermoelectric heating and cooling). Light might be controlled by light-tight packaging. Shock and vibration might be controlled by passive means such as padding or by more active means such as active vibration isolation.

Portability addresses the need to limit the size, weight, and power consumption of materials carried by the drone while also providing for product security, data provision, and environmental condition maintenance. Careful selection of low-weight materials can help accomplish this while also addressing needs such as robustness and thermal insulation. Limiting size and weight while also addressing needs for data acquisition and reporting may be accomplished by utilizing integrated circuits custom-designed and optimized to provide the various sensing and communications functionalities in a low-weight, compact container. It may also be accomplished, in some cases, by utilizing the drone power supply to power the container's electronics, thereby reducing the size of power supply in or on the package container or, in some cases, completely eliminating the need for a power supply in or on the container. Utilizing the drone power supply may allow the power supply in or on the container to be designed or selected for emergency, rather than routine, operation, thereby reducing the container's power supply size and weight. The container may also be programmed for intelligent power management, in order to power features on the container at optimal times to maximize the range of the drone. Similarly, the container may utilize the communications technologies on the drone for communicating data during flight. Utilizing the sensing and communications capabilities of the drone, rather than the container, during flight may provide advantages in terms of limiting potential electronic interference between the container's and drone's communications hardware.

Transferring data from the container to the drone may be accomplished through a direct electrical connection between the container and drone electronics or by wireless communications technologies such as Near Field Communication (NFC), by Bluetooth (including Bluetooth Low Energy), or other technologies known to those skilled in the art and which may exist now or in the future. Additionally, in some circumstances, there will be no need for communications from the container during flight, in which case all communications from the container may be disabled. This may be accomplished through the use of an NFC radio on the container recognizing an NFC tag on the drone, by a light sensor recognizing connection to the drone, by a camera on the container recognizing a designating image on the drone (including barcodes; Quick Response (QR) codes; images; drone visual features; or similar), or other means known by those skilled in the art and which may exist now or in the future. The container may also employ low-power communications such as Bluetooth Low-Energy to report data to local receivers, such as those that might be available in a ground-based facility, that communicate data to the cloud utilizing local infrastructure (including local Wi-Fi connecting to internet routers, the cell phone of the receiving party reporting data to the cloud, etc.). The power supply in or on the package container may be charged when not being used by being stored on a charging mat that charges the container by either wired or wireless connection (e.g. inductive charging). Data might also be communicated from the container to such a mat, again by wired or wireless connection, including Bluetooth, NFC/RFID, or other means known by those skilled in the art and which may exist now or in the future.

In one example, the container is of a rectangular box design comprising a top section that mates securely with a bottom section.

In another example, the container is of a shape, size and construction compatible with pneumatic tube transport systems.

In another example, the container is of a shape that minimizes air resistance during flight.

In one example, the container is removable from the drone.

In another example, the container is integrated into the drone so as to provide a non-removable payload bay.

In one example, access to the container contents is prevented by a lock that is only released by presentation of proper credentials or a physical key.

In another example, release of the container from the drone is prevented by a lock that is only released by presentation of proper credentials or a physical key.

In one example, the container may be unlocked by a mechanism that releases the latch upon fingerprint recognition of authorized users.

In another example, the container may be unlocked by a mechanism that releases the latch upon visual recognition of authorized users.

In another example, the container may be unlocked by a mechanism that releases the latch upon visual recognition of an image-based code.

In another example, the container may be unlocked by a mechanism that releases the latch upon recognition of an audible signal, which may include voice recognition.

In another example, the container may be unlocked by a mechanism that releases the latch upon gesture recognition.

In another example, the container may be unlocked by a mechanism that releases the latch upon keyed entry of a code through a keypad, which may be presented on a digital touchscreen or a physical keypad.

In another example, the container may be unlocked by a mechanism that releases the latch upon presentation of a wireless key, such as an RFID tag.

In another example, the container may be unlocked by a mechanism that releases the latch upon reception of a code or signal transmitted over a wireless network.

In one example, a physical key, which may for example be securely stored on-site, with access restricted through administrative procedures, may be used to open the container in case of electronics malfunction.

In one example, the container is constructed of a highly impact-resistant, low-weight material such as Acrylonitrile Butadiene Styrene (ABS).

In another example, the container is constructed of highly impact-resistant, low-weight composite materials such as glass fiber composites or carbon fiber composites.

In another example, the container is constructed from metal-based materials, such as metal oxides, which may be engineered to be “transparent” to electromagnetic energy or provide low electromagnetic interference.

In one example, the interior of the container is formed of a thin, low-weight insulating material, such as polystyrene, for temperature maintenance.

In another example, no insulating material is included for temperature maintenance.

In another example, temperature control is achieved through active heating and cooling.

In one example, a dispenser of an encasing substance, such as two-part foams or epoxies, is integrated to encase the payload contents under certain circumstances such as a crash or unauthorized access.

In another example, a dispenser of a destroying or inactivating substance is integrated into the container to prevent exposure or use of the payload contents under certain circumstances such as a crash or unauthorized access.

In one example, a breach of the container by a crash, impact, or attempts at unauthorized access is detected by use of a light sensor inside the container.

In another example, a breach of the container by a crash, impact, or attempts at unauthorized access is detected by use of an audio sensor.

In another example a breach of the container by a crash, impact, or attempts at unauthorized access is detected by use of conductive strips integrated into the walls and connection points of the container.

In one example, a crash, impact, or attempts at unauthorized access are detected by use of imaging accomplished by a camera integrated into the container.

In another example, a crash, impact, or attempts at unauthorized access are detected by use of acceleration and orientation sensors inside the container.

In an example, data collected from sensors indicating a crash, impact, or attempts at unauthorized access are recorded to the container's on-board memory.

In an example, responders are alerted to data corresponding with a crash, impact, or attempts at unauthorized access through the communications capabilities of the container or drone.

In one example, data sensing, processing, storage, and communications electronics, along with charging circuitry, are integrated onto a circuit board that is positioned, along with a power supply as needed, in the container.

In other example, one or multiple components of the circuit board described in the one embodiment are configured to be independent of the main circuit board.

In other example, one or multiple components of the circuit board described in the one embodiment are excluded in order to optimize a feature set for a given application.

In one example, sensors, which may be on the circuit board, measure temperature within the container.

In another example, sensors, which may be on the circuit board, measure atmospheric pressure within the container.

In another example, sensors, which may be on the circuit board, measure humidity within the container.

In another example, sensors, which may be on the circuit board, measure light exposure within the container.

In one example, gyroscopes, which may be on the circuit board, track the container orientation.

In one example, acceleration sensors, which may be on the circuit board, track the container accelerations including impact and vibration data.

In one example, a Global Navigation Satellite System (GNSS) receiver which may be on the circuit board, tracks the container's location.

In one example, cellular communications signals are used to determine and track the container's location.

In one example, data are recorded on a memory chip on the circuit board.

In another example, data are recorded on a memory chip independent of the circuit board.

In another example, data are recorded on a memory chip that is removable from the container.

In one example, data may be transmitted in real time or at specified times, as appropriate, over wireless networks by a wireless radio on the circuit board.

In one example, the wireless networks are cellular networks.

In another example, the wireless networks are Low Power Wide Area (LPWA) networks such as LoRaWAN®.

In one example, a GNSS beacon reports the container's location in the event that no cellular networks are available.

In one example, communications antennae are positioned about the container walls to maximize transmission and reception of wireless communications.

In one example, the circuit board contains a near-field communications (NFC) radio and NFC antenna for communications with the drone and for communications with readers at the dispatching and receiving locations.

In one example, the circuit board includes a camera for recognition of image-based indicators such as barcodes.

In one example of the camera, the camera and computing are used to recognize a visual indicator on the drone to register and record the identity of the drone used during transport.

In another example of the camera, the camera and computing are used to recognize a visual indicator on the drone to disable container communications while attached to the drone.

In another example of the camera, the camera and computing are used to identify, document, and/or authenticate a user.

In one example of the system, a “drone data link” device is mounted to the drone and linked to the drone electronics in such a way as to facilitate data exchange between the drone and container.

In one example of the drone data link, the drone data link contains an NFC radio and antenna for communication with the container.

In another example of the drone data link, the drone data link contains a physical connection point for wired communication with the container.

In one example of the drone data link, data from the container are communicated to the drone and transmitted over the drone's communications electronics when the container is properly engaged with the drone for transport.

In another example of the drone data link, data from the drone may also be delivered to the container for recording of drone-related data (e.g. drone identifier, flight altitudes, etc.) to the container memory.

In one example, charging devices at the dispatching and/or receiving sites wirelessly charge the container batteries.

In another example, charging of the container's power supply is accomplished by a wired connection.

In one example, data exchange devices at the dispatching and/or receiving sites utilize near field communication (NFC) for data exchange with the container.

In another example, data exchange devices at the dispatching and/or receiving sites utilize wired connections between the device and the container for data exchange with the container.

In another example, data exchange devices at the dispatching and/or receiving sites utilize Bluetooth or Bluetooth Low Energy for data exchange with the container.

In another example, data exchange devices at the dispatching and/or receiving sites utilize Wi-Fi for data exchange with the container.

In one example, data about the container's contents are recorded to the container's on-board memory chip. Such data may include, for example, product serial numbers, de-identified patient identifiers for patient specimens, instructions for laboratory testing of patient specimens, drug information, drone information, etc. Such data may be read and recorded at the dispatching and receiving sites.

In one example, barcodes of products being loaded into or removed from the container are read by the container's on-board camera for recording the container's contents to the container's on-board memory chip and to associated electronic data tracking systems.

In another example, an external barcode scanner wirelessly communicates with the container's electronics via, for example, Bluetooth or Bluetooth Low Energy communications, for recording the container's contents to the container's on-board memory chip and to associated electronic data tracking systems.

In another example, an RFID reader, either external to the container or integrated into the container, is used to read product data from product RFID tags for recording the container's contents to the container's on-board memory chip and to associated electronic data tracking systems.

Tables 1 and 2 below illustrate exemplary communications and charging modes for a smart container as described herein.

TABLE 1
Illustrative container communications modes
to different data infrastructure gateways
Data Infrastructure Gateway

| Direct | To | To radio receiver | To | To local | To |
|---|---|---|---|---|---|
| to | drone | (e.g. drone ground | recipient | data infra- | docking |
| Cloud | comms | control system) | cell phone | structure | station |
| Cellular | Physical | Radio, including | Bluetooth | Wi-Fi | Physical |
| | link | Cellular | | | link |
| GNSS | Blue- | WiFi | NFC | Docking | NFC |
| beacon | tooth | | | station | |
| Wi-Fi | NFC | — | — | Bluetooth | — |

TABLE 2
Illustrative container function power
sources and charge transfer methods

| | | Situation/ |
|---|---|---|
| Power source | Charge transfer methods | Location |
| On-board battery | Physical connection (plug), Remove | On- and/or |
| | & replace, Remove & recharge & | off-drone |
| | replace, Wireless/Inductive | |
| Drone | Physical connection (plug), | On-drone |
| | Wireless/Inductive | |
| Wireless device | Physical connection (plug), | Off-drone |
| | Wireless/Inductive | |

FIG. 1 is a perspective view of the smart container with a biometric sensor for unlatching of the lid to access contents of the smart container. Referring to FIG. 1, smart container 100 includes a top 102, a bottom (not visible in FIG. 1), and sidewalls 104 that define an interior region or enclosure 106 for holding high value or sensitive articles. In the illustrated example, top 102 is connected to one of sidewalls 104 via a hinge 108. A user may open container 100 by accessing biometric sensor 110, which in the illustrated example is a fingerprint sensor. Top 102, sidewalls 104, and the bottom may be formed of a thermally insulating material to maintain a desired temperature range in interior region 106 during transport of smart container 100 via drone. Smart container 100 may be formed of a lightweight material suitable for transport via drone. In one example, smart container 100 may be formed of continuous fiber thermoplastics including carbon or glass fibers impregnated with polycarbonate, thermoplastic polyurethane, or other thermoplastic resin. Smart container 100 may also be formed of radio frequency (RF) transparent materials, such as metal oxides or other insulators to allow communications between circuitry located within smart container 100 and devices external to smart container 100.

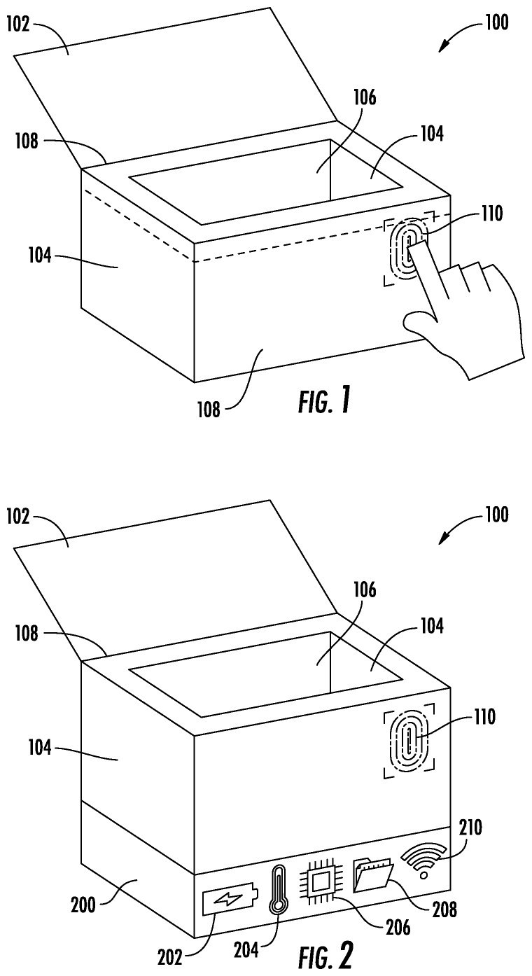

FIG. 2 is another perspective view of smart container 100 where a bottom portion 200 of smart container 100 includes a rechargeable power supply 202, a temperature sensor 204, a processor 206, memory 208, and RF communication circuitry 210. Power supply 202 may be a rechargeable battery that is rechargeable through interfacing with a charging system of a drone or a docking station for smart container 100. Temperature sensor 204 may be any suitable type of temperature sensor for sensing a temperature within interior region 106. Processor 206 may be a microprocessor for controlling the overall operations of smart container 100. Memory 208 may include solid state memory devices suitable for storing measurements generated by sensors 204 and for holding programs executable by processor 206. Communications circuitry 210 may communicate with external smart container content condition and delivery monitoring systems and with onboard sensors of a drone, as will be described in detail below. Although the example illustrated in FIG. 2 only includes a temperature sensor 204, other types of sensors may also be located onboard in container 100. For example, an accelerometer, a pressure sensor, a gyroscope, a humidity sensor, and/or a light sensor may be located in or on smart container 100. In addition, smart container 100 may include a location circuit, such as a global positioning system (GPS) receiver or a mobile communications network location receiver, that generates output indicative of the location of smart container 100. Example uses of such sensors and location circuitry will be described in detail below.

FIG. 3 is a perspective view of an alternate configuration of smart container 100 where smart container 100 includes a cylindrical housing designed for compatibility with a pneumatic tube system of a facility, such as a hospital. Pneumatic tube systems are used to transfer biological specimens, chemicals, and other articles between locations in a hospital. Designing smart container 100 to be compatible with a pneumatic tube system allows smart container 100 to be delivered from one medical facility to another and to be transported within the pneumatic tube system of either facility.

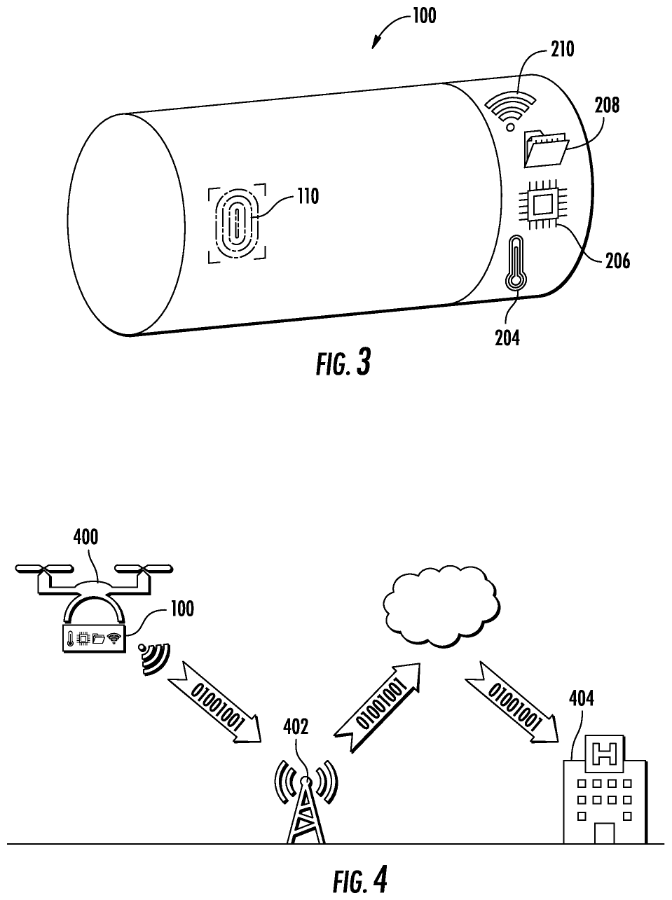

FIG. 4 is a network diagram illustrating transport of smart container 100 via drone 400, where the drone is an aerial vehicle. In the illustrated example, smart container 100 communicates with an external smart container contents condition and delivery monitoring system via a wireless communications network 402. In the illustrated example, smart container 100 and/or drone 400 transmits data via wireless network 402 to a smart container contents condition and delivery monitoring system located at medical facility 404. The communications may be directly from communication circuitry of smart container 100 or through communication circuitry of drone 400. The communications in FIG. 4 occur in real time during flight of drone 400.

Thus, in FIG. 4, a facility such as medical facility 404 may receive real time updates concerning the conditions of the contents of smart container 100 during flight. As an example, medical facility 404 may receive continuous updates of sensor measurements, corresponding location data, and an indication of whether the sensor measurements are normal or abnormal given the context provided by the location data. For example, an indication that the smart container has been opened may be acceptable while the smart container is being loaded or unloaded at the origin or destination of a delivery but not acceptable at another ground location other than the origin or destination or during flight. Similarly, vibration measurements output by an accelerometer may have different threshold levels to indicate tampering during loading, unloading, and flight. Pressure and temperature output values may have one range that is acceptable during loading and unloading and another range when the container is closed during transit.

FIG. 5 is a network diagram illustrating smart container 100 communicating with smart container contents condition and delivery monitoring system associated with facility 404 while smart container 100 is located on the ground. Such communication may occur prior to delivery of smart container 100, for example, to inform the smart container contents condition and delivery monitoring system that the smart container is ready for pickup by a drone. In another example, the communication may include sensor value readings, such as pressure, temperature, light, and humidity readings that occur before the initiation of transit. Such readings may be used as baseline measurements to compare with subsequent readings that occur during transit to generate output indicative of the condition of contents of smart container 100.

As indicated above, in one example, smart container 100 communicates with external devices via the communication system of drone 400. FIG. 6 illustrates such an example. In FIG. 6, communication circuitry 210 of smart container 100 communicates with an external communication system of drone 400. The external communication system of drone 400 communicates the data from smart container 100 to external devices such as the smart container contents condition and delivery monitoring system. The communications between smart container 100 and drone 400 may occur over a wireless or wired interface.

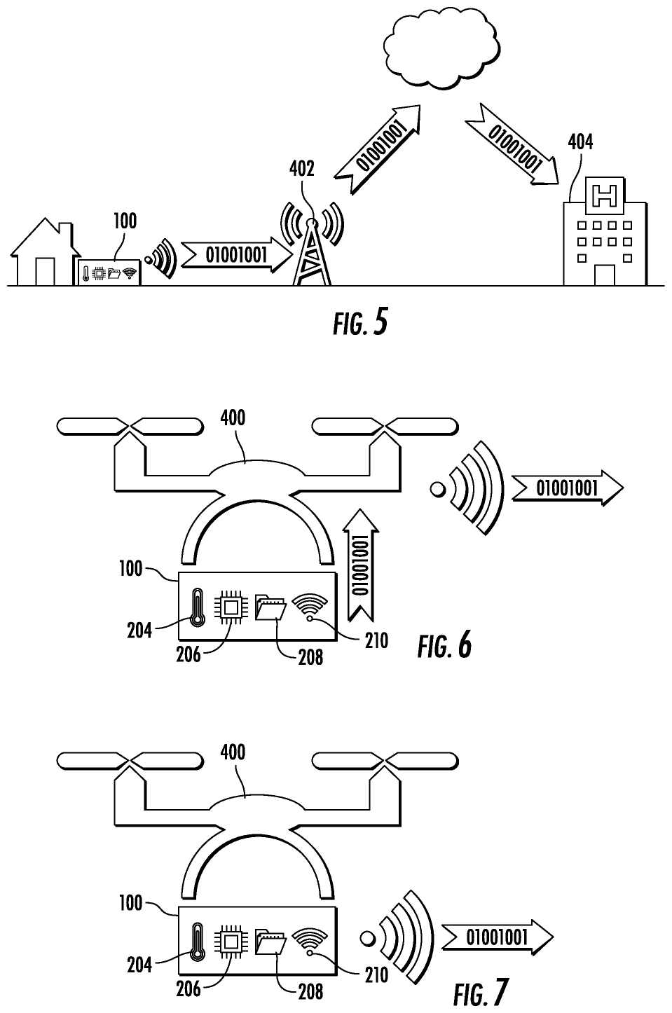

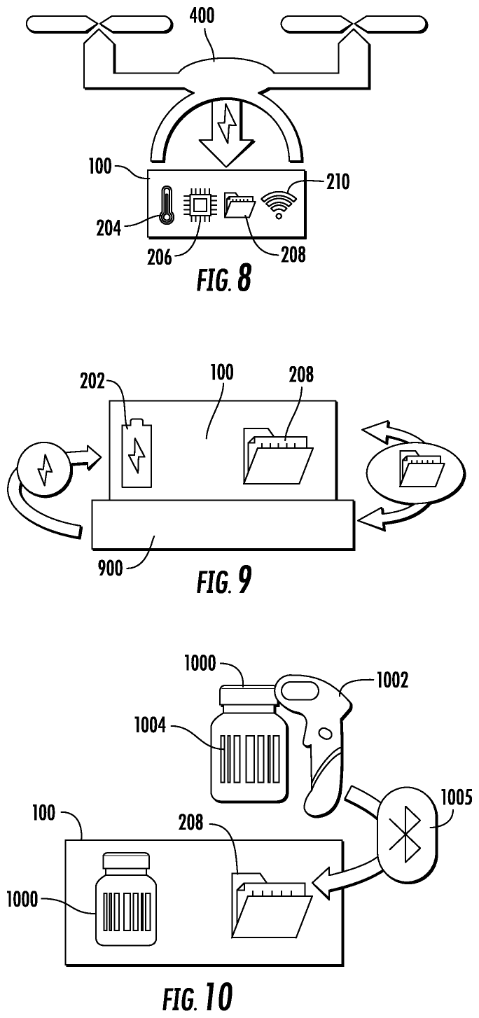

As stated above, in another example, smart container 100 may communicate directly with external systems. FIG. 7 illustrates such an example, in FIG. 7, communication circuitry of smart container 100 communicates with external systems, such as the external smart container contents condition and delivery monitoring system directly without using the onboard communications functionality of drone 400.

In another example configuration, container 100 may be powered at least partially by drone 400. FIG. 8 illustrates such an example. In FIG. 8, smart container 100 receives energy from drone 400 and stores and/or uses the energy to power onboard devices, such as processor 206, of smart container 100. Smart container 100 may include an onboard power supply or energy storage device, such as a battery. In an alternate example, smart container 100 may be powered directly from drone 400 without an onboard energy storage device.

In another example, smart container 100 may implement data communications and charging when interfaced with a docking station. FIG. 9 illustrates such an example. In FIG. 9, smart container 100 may be coupled to docking station 900 via a wired or wireless interface. Smart container 100 receives charging energy from docking station 900 and also communicates data from memory 208 to docking station 900.

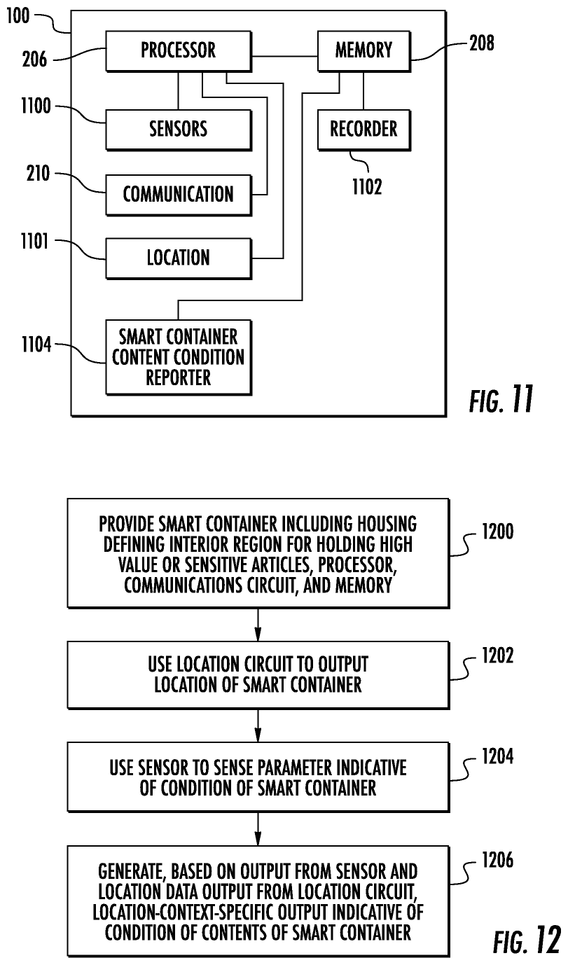

In another example, smart container 100 may store data about its contents in memory 208. Smart container 100 may be programmed with information about its contents or may receive the information about its contents from an external device, such as a barcode scanner. FIG. 10 illustrates an example where memory 208 receives data about contents 1000 via a barcode scanner 1002. In the illustrated example, when a user scans a barcode 1004 on contents 1000, the barcode scanner 1002 communicates the information contained in the barcode to smart container memory 208. The communication mechanism may be any suitable wired or wireless medium. In the illustrated example, a Bluetooth communications link 1005 is used to communicate the data from scanner 1002 to memory 208. Storing information about the contents in smart container 100 allows verification of the contents at the delivery destination and association of smart container content conditions with identifiers of the smart container contents.

FIG. 11 is a block diagram illustrating exemplary electronic components of smart container 100. In the illustrated example, smart container 100 includes a processor 206 and memory 208 as described above. Smart container 100 may also include one or more sensors 1100 that include, for example, accelerometers, gyroscopes, optical sensors, temperature sensors, humidity sensors, or other sensors for sensing environmental conditions and/or for monitoring content conditions. Alternatively, sensors 1100 may be on-board sensors of a drone used to transport smart container 100. Smart container 100 may also include a location circuit 1101 that receives or generates output indicating the location of smart container 100. In one example, location circuit 1101 may be a GPS receiver or a mobile communications network location receiver that receives its location from external signals, such as GPS signals or mobile communications network signals. Location circuit 1101 may generate output indicating the location of smart container 100. Such output may be used to give context to measurements from sensors 1100. Alternatively, location circuit 1101 can be an on-board circuit of a drone used to transport smart container 100.

Smart container 100 may also include one or more hardware and/or software modules, such as recorder 1102, which records measurements generated by sensors 1100 and stores the measurements in memory 208. Smart container 100 may further include a smart container content condition reporter 1104 which reads the measurements from memory 208 or receives the measurements generated by sensors 1100 in real time and generates output indicative of the condition of contents of smart container 100 before, during, and after transport of smart container 100.

Smart container content condition reporter 1104 may utilize output from location circuit 1101 to give context to measurements produced by sensors 1100 with respect to smart container content condition. For example, sensors 1100 may include an accelerometer or a gyroscope to generate output indicative of a rate of change in position or orientation of smart container 100. Location circuit 1101 may output location information for smart container 100 before, during, and after transit. If the rate of change in position is high when transit is started, such a measurement may be considered normal. However, if the rate of change in position is high during transit at a location other than the destination, such a measurement may be considered abnormal, and smart container content condition reporter 1104 may generate corresponding output indicating possible tampering or damage to contents of smart container 100. In another example, if the sensors are environmental sensors, such as light sensors, high light intensity values during loading and unloading may be expected and considered normal. However, high light intensity values during transit when the container is supposed to be closed may be considered abnormal, and smart container content condition reporter 1104 may generate a location-context-specific interpretation of sensor output indicating an abnormality.

FIG. 12 is a flow chart illustrating an exemplary process for drone based delivery of sensitive or high value articles. Referring to FIG. 12, in step 1200, the process includes providing a smart container including a housing defining an interior region for holding high value or sensitive articles, a processor, a communication circuit, and a memory. For example, a smart container, such as that illustrated in FIG. 1-11 or 13A-16 may be provided.

In step 1202, the process includes using the location circuit to output the location of the smart container. For example, location circuit 1101 may receive or generate output indicative of the location of smart container 100 before, during, and after transport of its contents.

In step 1204, the process includes using a sensor to sense a parameter indicative of a condition of the smart container. For example, one or more sensors 1100 may output physical, environmental, or other parameters indicative of a change in the environment, rate of change of position, orientation, or other parameters associated with smart container 100.

In step 1206, the process includes generating, based on output from the sensor and the location data output from the location circuit, location-context-specific output indicative of a condition of the contents of smart container 100. For example, smart container content condition reporter 1104 may generate output that indicates the condition of contents of smart container 100 given the location data output from location circuit 1101 and the sensor data output from one or more sensors 1100. Examples of such location-context-specific output are described above.

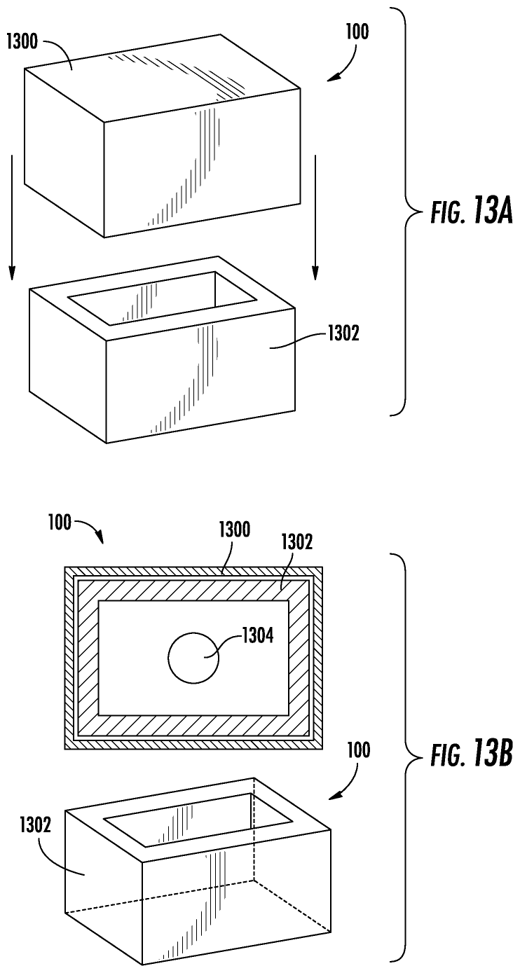

FIGS. 13A and 13B illustrate an alternate configuration of smart container 100. In FIG. 13A container 100 includes a first portion 1300 and a second portion 1302 where first portion 1300 encloses second portion 1302. The top part of FIG. 13B illustrates the sidewalls of portion 1300 fully enclosing the sidewalls of portion 1302. A locking mechanism 1304 may be integrated within the second portion 1302 to lock portions 1300 and 1302 together. In one example, locking mechanism 1304 may be included to restrict access to contents of smart container 100. In another example, locking mechanism 1304 may be included to control access. Locking mechanism may be actuated by any suitable mechanism, such as a numeric code input via a keypad, a numeric code transmitted to smart container 100 wirelessly, RF ID tags, biometrics, or using a physical key. The bottom part of FIG. 13B illustrates second container portion 1302 in perspective.

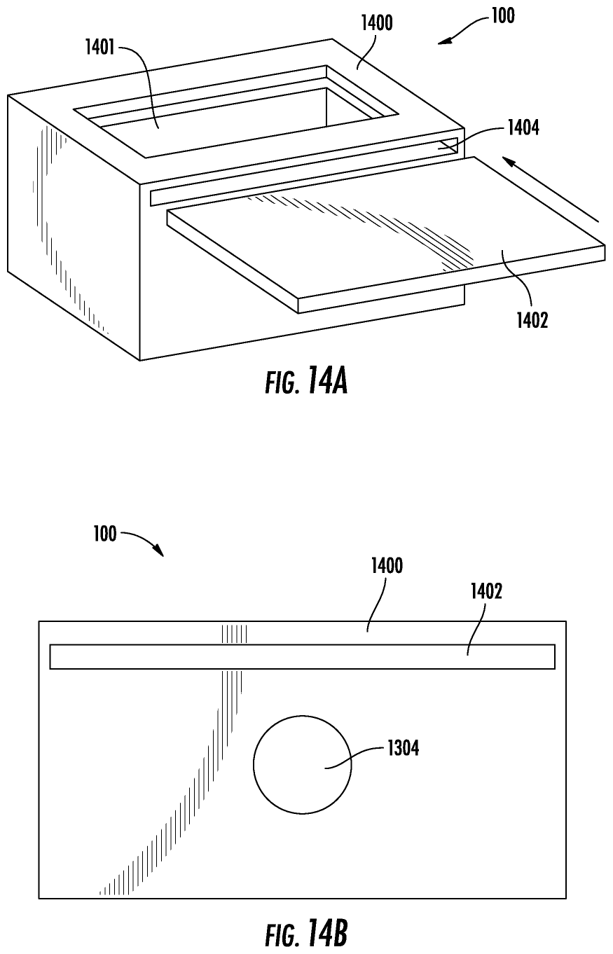

FIG. 14A illustrates an alternate configuration of smart container 100. In FIG. 14A, smart container 100 includes a first portion 1400 defining an opening 1401 and the slidable member 1402 that slides in a slot 1404 in one of the sidewalls of portion 1400 to cover opening 1401. FIG. 14B illustrates smart container 100 of FIG. 14A with slidable member 1402 fully engaged within slot 1404. Locking mechanism 1304 may also be included to lock slidable member 1402 within slot 1404.

FIG. 15 illustrates details of locking mechanism 1304 and associated components with the configuration of the container 100 illustrated in FIGS. 13A and 13B. In FIG. 15, locking mechanism 1304 is a rotating or actuating member rotated by a servomotor 1305 to move bolts 1500 to engage recesses 1501 in first container portion 1300. When locking mechanism 1304 rotates in one direction, bolts 1500 engage recesses 1501. When locking mechanism 1304 rotates in an opposite direction, bolts 1500 slide inward and disengage recesses 1501 to allow portions 1300 and 1302 to be separated from each other. In another example, locking mechanism 1304 may include one or more linear actuators for moving bolts 1500 into and withdrawing bolts 1500 from recesses 1501.

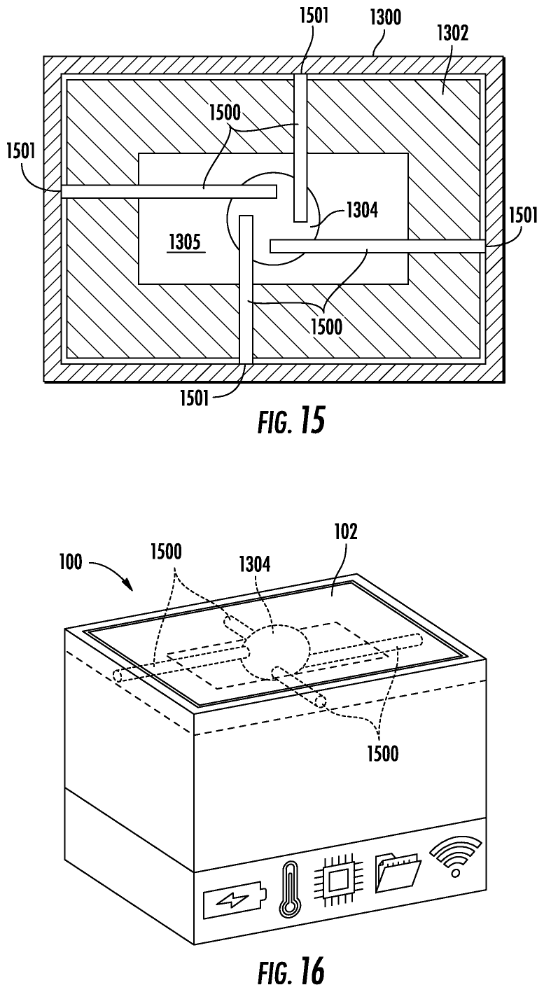

Locking mechanism 1304 and its associated components can be incorporated in any of the smart container designed described herein. FIG. 16 illustrates an example where locking mechanism 1304 is integrated within top 102 of smart container 100 illustrated in FIG. 2. The operation of locking mechanism 1304 is the same as that described above with regard to FIG. 15.

The subject matter disclosed herein is distinguished from existing solutions by, at least one or more of:
the combination of key elements necessary to meet the particular needs and regulations related to the drone transport of medical products—specifically, needs related to security, data, environmental conditions and portability;
the disablement of the container communications electronics while connected to the drone;
the use of a form factor compatible with pneumatic tube transport systems;
the use of a drone's sensing, communications, and energy supply to support the sensing, communication, and temperature maintenance needs of the container;
the use of a charging and data communications device to charge and exchange data with the container;
the use of location data to provide context for interpreting content condition sensor data; and
the use of internal or external data collection devices (e.g. barcode scanners) to collect and communicate data to the container's memory for storage and exchange of data related to the container's contents.
   A smart package container and associated systems provide for the safe and secure delivery of medical products and other sensitive or high-value products by drone. The solution addresses four key elements for safely and securely delivering such products by drone—specifically, it incorporates features to 1) ensure product security; 2) provide data acquisition and reporting; 3) maintain appropriate environmental conditions; and 4) facilitate portability. The solution may employ various technological means to address these needs, as the situation requires and as disclosed herein. Items to be delivered may include a variety of products used in healthcare, including supplies, medications, patient specimens for lab testing, implantable devices, organs, blood products, and other sensitive or high-value products.

While certain illustrative examples have been described, it is evident that many alternatives, modifications, permutations and variations will become apparent to those skilled in the art in light of the foregoing description.

What is claimed is:

1. A system for drone-based delivery of sensitive or high-value articles, the system comprising:
a smart container having a housing defining an interior region for holding sensitive or high-value articles and an exterior region configured for transport using a drone;
a processor, a memory, and a communications circuit coupled to the housing;
a location circuit for outputting location data indicative of a location of the smart container;
a sensor for sensing a parameter indicative of a condition of the smart container and for generating output indicative of the condition; and
a smart container content condition reporter for generating, based on the output from the sensor and the location data output by the location circuit, location-context-specific output indicative of a condition of contents of the smart container given a location of the smart container when the output from the sensor is generated.

2. The system of claim 1 wherein the housing includes a first portion and a second portion, the first portion and the second portion each including at least one sidewall, where the at least one sidewall of the first portion fully encloses the at least one sidewall of the second portion.

3. The system of claim 1 wherein the housing includes an opening to allow access to the interior region and at least one slidable panel for sliding over the opening to block access to the interior region.

4. The system of claim 1 wherein the housing includes an opening to allow access to the interior region, a hinge, and a cover coupled to the housing via the hinge, wherein the cover includes a first position for preventing access to the interior region and a second position for allowing access to the interior region.

5. The system of claim 1 comprising a locking mechanism integrated within the housing, the locking mechanism including an actuating member and a plurality of bolts coupled to the actuating member, wherein the actuating member is movable to a first position such that the bolts engage recesses in the housing and to a second position such that the bolts disengage the recesses in the housing.

6. The system of claim 1 wherein the housing comprises a cylinder configured for drone delivery and for transport by a pneumatic tube transport system of a facility.

7. The system of claim 1 wherein the location circuit comprises one of: a global positioning system receiver and a mobile communications network location receiver that receives or determines the location based on signals from a mobile communications network.

8. The system of claim 1 wherein the sensor comprises an on-board sensor of the drone.

9. The system of claim 1 wherein the sensor comprises an on-board sensor of the smart container.

10. The system of claim 1 wherein the output from the sensor indicates at least one of position and orientation of the smart container, and smart container content condition reporter is configured to determine the condition of the contents of the smart container given a location of the smart container when the output from the sensor is generated.

11. The system of claim 1 wherein the sensor comprises an environmental sensor and the output from the sensor includes values of an environmental parameter in the interior region and wherein the smart container content condition reporter is configured to determine the condition of the contents of the smart container given a location of the smart container when the output from the sensor is generated.

12. The system of claim 1 comprising a power supply located within or on the housing or on the drone.

13. The system of claim 1 wherein the communications circuit communicates with a smart container contents condition and delivery monitoring system via communication circuitry of the drone.

14. The system of claim 1 wherein communications circuit communicates with a smart container contents condition and delivery monitoring system directly without using communications circuitry of the drone.

15. The system of claim 1 wherein the communications circuit is configured to communicate the output indicative of the condition of the contents of the smart container to a smart container contents condition and delivery monitoring system during transport of the smart container by the drone.

16. The system of claim 1 wherein the smart container content condition reporter is configured to record the output indicative of the condition of the contents of the smart container in the memory and wherein the communications circuit is configured to communicate the output to the smart container content condition and delivery monitoring system at an endpoint of the delivery.

17. The system of claim 1 wherein the drone comprises an unattended aerial vehicle.

18. The system of claim 1 wherein the drone comprises an unattended ground vehicle or unattended water vehicle.

19. A method for drone-based delivery of sensitive or high-value articles, the method comprising:
providing a smart container having a housing defining an interior region for holding sensitive or high-value articles and an exterior region configured for transport using a drone, a processor, a memory, and a communications circuit;
using a location circuit for outputting location data indicative of a location of the smart container;
using a sensor for sensing a parameter indicative of a condition of the smart container and for generating output indicative of the condition; and
using a smart container content condition reporter for generating, based on the output from the sensor and the location data output by the location circuit, location-context-specific output indicative of a condition of the contents of the smart container given a location of the smart container when the output from the sensor is generated.

20. A non-transitory computer readable medium having stored thereon executable instructions that when executed by a processor of a computer control the computer to perform steps comprising:
in a smart container having a housing defining an interior region for holding sensitive or high-value articles and an exterior region configured for transport using a drone, a processor, a memory, and a communications circuit, initiating a smart container content condition reporter;
receiving, by the smart container content condition reporter, location data output from a location circuit and indicative of a location of the smart container;
receiving, by the smart container content condition reporter, output from a sensor that senses a parameter indicative of a condition of the smart container;
generating, by the smart container content condition reporter and based on the output from the sensor and the location data output by the location circuit, location-context-specific output indicative of a condition of the contents of the smart container given a location of the smart container when the output from the sensor is generated.
